(19) United States
(12) Patent Application Publication
(10) Pub. No.: US 2009/0147698 A1
(43) Pub. Date: Jun. 11, 2009

(54) NETWORK AUTOMATIC DISCOVERY METHOD AND SYSTEM

(75) Inventor: Pascal Potvin, Laval (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/951,899

(22) Filed: Dec. 6, 2007

(51) Int. Cl. H04L 12/28

(52) U.S. Cl. 370/254

(57) ABSTRACT

An automatic network discovery method and device enables network peer nodes to discover one another. A node entering a network has the burden of initiating a connection to peers potentially existing on the network. The incoming node and potential peer nodes each keep a persistent list of at least one potential peer node called a seed list, which is used at startup or restart to initially populate a peer list also kept by each node. The incoming node sends a connection request to the potential peers in its peer list. Through the connection requests and responses to the requests from the potential peer nodes, nodes exchange connection information regarding one another and other potential peer nodes on the network, which is stored in their respective peer lists.

### FIELD OF THE INVENTION

The present invention relates to a method and system for node discovery in a network, and more particularly, to protocol for automatic discovery by nodes in a network.

### BACKGROUND

Network discovery involves finding out which computers, printers, switches, routers, modems, servers, storage systems or other devices are connected to the network. The discovery process typically involves finding information about devices linked to the network, for example, a device's IP address, its type, and capabilities. Currently, it may be possible to automatically discover some network components using multicast protocol, such as Internet Group Management Protocol (IGMP) between the node system and the external router for group membership discovery. However, multicast protocol is not widely supported through the Internet. To circumvent such shortcomings, some products on the market have their own network automatic discovery mechanisms that are generally based on newcomer nodes obtaining the network topology information from a few server nodes.

In a fairly stable environment, server nodes providing the network topology to newcomer nodes may be sufficient. However, if the availability of those server nodes cannot be guaranteed, automatic discovery of the network topology is put at risk.

### SUMMARY

Automatic network discovery protocols enable network nodes to discover one another as one or more peer node enters the network community. In one aspect, a node entering a network has the burden of initiating a connection to potential peers existing on the network.

The incoming node and potential peer nodes each maintain a persistent list of at least one potential peer node, which may be used at startup or restart to initially populate a peer list kept at each node. The incoming node begins discovery of remote potential peers listed in the peer list, and possibly other nodes presently connected to the network, by first determining whether each of the remote nodes at the addresses stored in the peer list are reachable, for example, by sending a probe message to the remote potential peers. If the potential peer node is reachable, the incoming node sends a connection request message to that node.

A connection request contains any node addresses from the requesting node's peer list for which it has established a connection. Each potential peer node responding to the request replies with a message containing the address of any node in its own peer list that it has established connection with. In this way, the incoming node establishes a connection to each replying remote node, informs each replying remote node of other remote nodes it has established a connection with, and receives information about other potential peer nodes on the network from each replying remote node.

It should be emphasized that the terms “comprises” and “comprising,” when used in this specification, are taken to specify the presence of stated features, integers, steps or components; but the use of these terms does not preclude the presence or addition of one or more other features, integers, steps, components or groups thereof.

It is to be understood that both the foregoing general description and the following detailed description are exemplary and exemplary only and are not restrictive of the invention, as claimed.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 is a diagram of a community of peer nodes in accordance with an exemplary embodiment.

FIG. 2 is high level a block diagram representing an exemplary discovery protocol present on a peer node connected to network.

FIG. 3 is a flowchart of an exemplary startup/restart procedure in accordance with some embodiments.

FIG. 4 is a flowchart of an exemplary peer detection procedure that sends probe messages to address elements in a peer list in accordance with some embodiments.

FIG. 5 a flowchart of an exemplary connection request procedure performed by a network node in accordance with some embodiments.

FIG. 6 is a flowchart of an exemplary receive connection request procedure performed by a network node in response to receiving a connection request in accordance with some embodiments.

FIG. 7 is a flowchart of an exemplary receive connection response procedure performed at a node in response to receiving a response to a connection request in accordance with some embodiments.

FIG. 8 is a flowchart of an exemplary pending maintenance procedure performed by a network node to remove address elements in the peer list for which a timeout occurred in accordance with some embodiments.

FIG. 9 is a flowchart of an exemplary receive KA procedure performed at a node in response to receiving a presence message in accordance with some embodiments.

FIG. 10 is a flowchart of an exemplary maintenance KA procedure performed at a node for detecting KA timeouts of node address elements in the peer list in accordance with some embodiments.

### DETAILED DESCRIPTION

The various features of the invention will now be described with reference to the figures. These various aspects are described hereafter in greater detail in connection with a number of exemplary embodiments to facilitate an understanding of the invention, but should not be construed as limited to these embodiments. Rather, these embodiments are provided so that the disclosure will be thorough and complete, and will fully convey the scope of the invention to those skilled in the art.

Many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions, such as program modules, being executed by one or more processors, or by a combination of both. Moreover, the invention can additionally be considered to be embodied entirely within any form of computer readable carrier, such as solid-state memory, magnetic disk, and optical disk containing an appropriate set of computer instructions, such as program modules, and data structures that would cause a processor to carry out the techniques described herein. A computer-readable medium would include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (EPROM or Flash memory), an optical fiber, and a portable compact disc read-only memory (CD-ROM), or any other medium capable of storing information. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. Thus, the various aspects of the invention may be embodied in many different forms, and all such forms are contemplated to be within the scope of the invention.

A network can be considered as a collection of linked devices called nodes, each of which is connected to at least one other node. A node may include a switching device having wired, optical and/or wireless connections. For example, a node may be a router or switch handling packet streams, a combination router-switch handling connections and packet traffic, a bridge or a hub. A node also may include a personal computer (PC), personal digital assistant, cell phone, set top box, server computer, hand-held device, laptop device, multiprocessor system, microprocessor-based system, programmable consumer electronics, network PC, minicomputer, mainframe computer, printer, scanner, camera, or other general purpose or application specific device. A node may support a large number of information sources and receivers that dynamically exchange information, or have fixed source/receiving roles, of varying activity. For instance, a node in some embodiments may comprise a system in a local area network (LAN) and/or a wireless LAN (WLAN), a system in an enterprise network, a system connected to a WAN via a gateway, a system providing subscribers operating user equipment (e.g., a mobile or fixed communication device) access to any of several networks (e.g., PSTN, IP WAN, ISDN), or combinations thereof.

Nodes may form a smaller network within a larger network. For example, node systems may be added to form an autonomous network, called a “community,” with IP-based interconnectivity. Alternatively, a community may include most or all nodes communicating in a network. A community may operate in a dynamic environment in which individual node devices or systems join or leave the community at any time. Also, the physical distance between nodes may be fixed, change intermittently, change continuously, and/or change as a result of a combination of fixed and mobile nodes. Inter-device protocols run on each node system to disseminate information about the node systems throughout the community and enable the nodes to automatically discover one another.

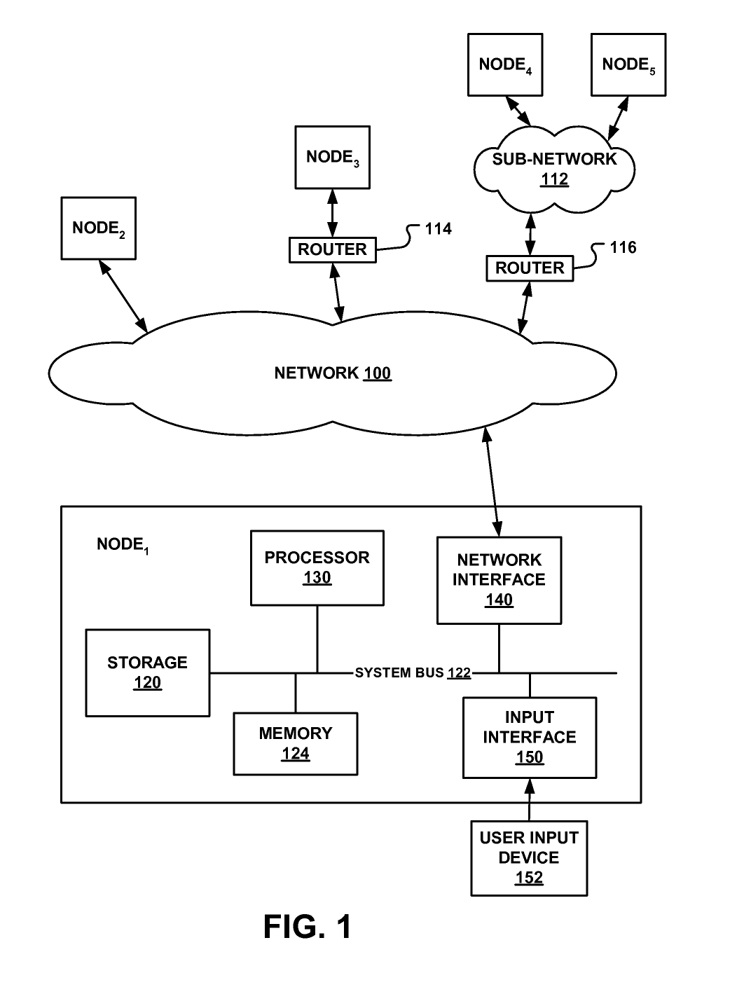

Reference is now made to FIG. 1, which shows an exemplary network 100 including a community of nodes consistent with some embodiments. For ease of explanation, FIG. 1 shows five peer nodes: NODE₁, NODE₂, NODE₃, NODE₄, and NODE₅, but it should be appreciated that a fewer or greater number of peer nodes may be present or operating at any instant in time. Additionally, it should be appreciated that network 100 may include nodes that may are not operate to discover peers as described herein, such that discovery among peers pertains to a community that comprises a subgroup of all nodes connected to the network. Furthermore, it should be understood that the network shown in FIG. 1 is only one example of a network configuration, and thus any practical number and combination of peer nodes including sub-networks and linking elements, such as hubs, switches, bridges or routers, may be present in a given implementation. For example, a peer also may form part of a one or more sub-network 112 of nodes connectable to the network 100 by way of an intermediate device. In some embodiments, NODE₄ and NODE₅ may be connected to the network 100 via a router 116, although other intermediate peer devices may be used, such as a modem, hub, switch, bridge, a router/bridge combination or router/switch combination. The network 100 may be a local area network (LAN), a wireless local area network (WLAN), a combination of a LAN and WLAN, a wide area network (WAN), a virtual network or other types of networks. For example, the network 100 and sub-network 112 may implement Ethernet protocol (e.g., the IEEE 802.3 standard), one of the IEEE 802.11 standards, combinations of IEEE 802.x standards, an IP-based network (e.g., an IPv4 and IPv6 Internet or intranet, or other type of data packet network (PDN)), and other types and/or combinations of networks. In some embodiments, each peer NODE₁ to NODE₅ may be identified by a unique address, such as an IP address, although nodes in some network implementations may use other types of addresses and protocols, such as a MAC address.

As shown in FIG. 1, the network 100 provides interconnectivity between NODE₁ to NODE₅, although communication between NODE₄ and NODE₅ may be carried out only within sub-network 112. Each node also may provide connectivity to one or more other networks, such as a PSTN and ISDN (not shown). Furthermore, each of the routers 114 and 116, as well as any other switch, bridge or hub that may be present in the network 100 and sub-network 112 may be considered node systems within the context of the present invention.

FIG. 1 shows components of an exemplary peer system, NODE₁, in greater detail. NODE₁ may include storage 120, memory 124, a processor 130, a system bus 122 that couples various node system components to the processor 130, a network interface 140, and an input interface 150. It should be appreciated that the various peers connectable to a community in the network at any moment in time may have different underlying architectures, but are capable of storing the discovery program modules, data structures and timers/counters described herein and executing these program modules. For example, the NODE₁ system may be a PC, while the NODE₂ system may be another application(s) specific device (e.g., a printer, scanner, set top box, soft phone, network PC, device providing radio access network and/or core network functionality, switch, hub, router etc.).

The storage 120 is typically non-volatile (i.e., persistent) computer storage media that may include, but is not limited to, magnetic disk storage, magnetic cassettes, magnetic tape or other magnetic storage devices, ROM, CD-ROM, digital versatile disks (DVD) or other optical disk storage, EPROM, EEPROM flash memory and/or any other medium which may be used to store the desired information and which may accessed by the system. Memory 124 is typically volatile memory located on or near the processor (e.g., on the processor board) and may replicate all or parts of the data and/or program modules stored in non-volatile memory to enable fast memory access. Volatile memory includes, but is not limited to RAM, static RAM (SRAM), or other volatile memory technology. The storage 120 and or memory 124 may include data and/or program modules that are executable by the processor 130. If a peer is part of a distributive processing environment, storage 120 may include program modules located in local and/or remote computer storage media including memory storage devices.

The network interface 140 may be a network card or adaptor to provide the peer a way to connect and communicate over the network, for example, a LAN. Alternatively, a peer may include a router and/or modem to connect to network 100, for example, if the network were an IP-based WAN, through the network interface 140 and a router, or through an internally or externally provided modem (not shown).

The input interface 150, which may or may not be included with other peer systems in the network 100, allows users to interact with the NODE₁ through a user input device 152. In some embodiments, user input devices may include a keyboard, mouse or other pointing device, microphone, touch display screen, or other activation or input devices known in the art.

In some embodiments, the input interface 150 may include at least one Node B controlled by a radio network controller (RNC) that allow a user input device 152, such as a mobile terminal, to communicate with other mobile terminals or network nodes, such as with NODE₁ or any of remote NODE₂ to NODE₅, or other user devices connecting though those remote nodes. For example, peers on network 100 may comprise a UMTS system supporting circuit-switched and packet-switched calls, short messages, voice mails and group calls. It may provide all these services to mobile terminals in its own radio coverage area (e.g., via a radio network subsystem (RNS) or base station subsystem (BSS)) even if it has no connectivity to an IP WAN or the PSTN. Each system also may connect to the external IP WAN implementation of network 100 and support terminal-to-terminal traffic and terminal to the trusted PSTN calls (and vice versa) among the peers.

The individual peers, for example, any one of NODE₁ to NODE₅ may be added to the network 100 in an ad-hoc manner to form a community with IP-based interconnectivity. For purposes of explanation, the term “local” is used herein in the context of a peer (i.e., any node potentially connectable as a community member) currently being considered, as opposed to the other “remote” peers in a community. For example, in the following description, a local peer is the node executing one or more program modules or routines, and data structures, timers/counters etc. associated with that peer also may be designated as “local.” Thus, any peer in the community may be considered a “local” peer in the context of “this peer,” while peers at locations in the network other than the local peer are considered “remote.” However, it is to be understood that a local peer may store data structures and keep timers/counters relating to one or more remote peer.

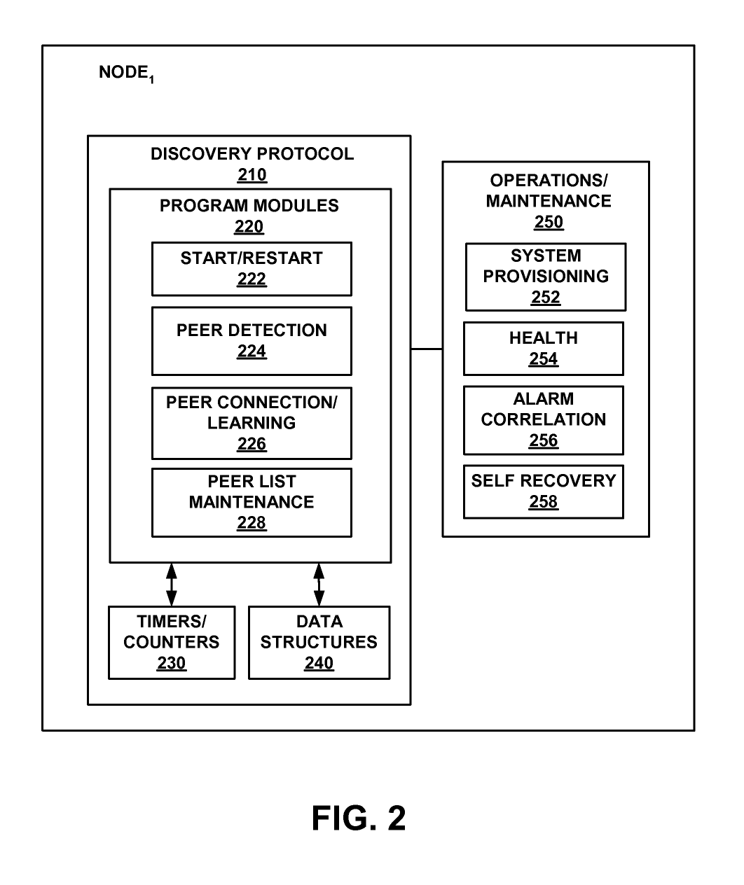

FIG. 2 is a high-level block diagram representing an exemplary discovery protocol 210 including program modules 220 stored in storage 120 and/or memory 124 of a peer. Each peer forming or participating in a community includes the program modules 220 stored in its memory 124 and/or storage 120 to perform the discovery protocol 210. The program modules make use of timers/counters 230 and data structures 240 to perform discovery and discovery updates of peers present on the network 100.

The discovery protocol 210 enables the peers to automatically discover one another in a network a with limited initial configuration data. The discovery protocol includes a start/restart module 222, a peer detection module 224, a peer connection/learning module 226, and a peer list maintenance module 228. While the program modules 220 are depicted as separate processes, some embodiments may merge some or all of the tasks performed by the various modules. For example, some or all of the processes performed by the peer detection module 224 and peer maintenance module 228 may be merged background processes performed while other program processes related to peer connection are running. Conversely, some tasks performed within a single depicted module may be performed as separate modules. For example, the peer connection/learning module 226 can be viewed as including several tasks that may be performed independently, but may logically be viewed as a single process with some receive queue, timeout events and regular processing.

A peer node system in accordance with some embodiments also may include an operating system program, or another subsystem or program controlling the discovery protocol. For example, FIG. 2 shows an exemplary Operations and Maintenance (O&M) application program 250 having modules for system provisioning 252, health monitoring 254, alarm correlation 256 and self-recovery 258. The O&M program may be integrated with the discovery protocol 210 to implement community features. For example, the O&M program 250 may control the entire peer system and present a simplified and integrated management view of the system to an operator. An operator does not necessarily have to configure each component of an individual peer's system to bring the system into service.

In some embodiments, an O&M program 250 may keep components of a standard core network oblivious of the special features of a peer system. For example, a peer system may include a home location register (HLR) and each HLR is kept unaware of the fact that its contents are replicated in all the peer systems in the community. Actions of the O&M program 250 may be used to extract the HLR contents, distribute them, and add profiles learned from other peer systems. The HLR may not distinguish these software-initiated actions from operator-initiated actions.

The discovery protocol modules 220 make use of data structures 240, such as a plurality of lists, and a plurality of timers and/or counters 230. Before describing the procedures performed by the various program modules 222-228, elements of an exemplary discovery protocol are first described:

Peer

A node system is a “peer” of another node system if both are capable of communicating with one another in a network community and one is capable of discovering the other.

Timeout

A timeout occurs when a period of time elapses and is equal to or greater than a predetermined amount. A timeout may cause one or more action to be carried out. A variety of timers may measure timeout periods related to various processes.

Timestamp

A timestamp, as used herein, refers to any mechanism for indicating the instant in time when something happened and may serve as a reference point for which to start a timeout timer and/or to compare against an elapsed amount of time (e.g., a timeout period) since the Timestamp.

Seed List

A “Seed List” (SL) is a data structure stored in persistent memory of each peer system. The SL includes one or more addresses utilized by the discovery protocol 210, for example, in start/restart program module 222 to initiate sending a probe message to one or more potential peer nodes. For example, a node entering a network may send a Ping command to each SL address to discover whether those nodes are reachable across the network. Particular addresses listed in the SL (e.g., IP addresses) may be configured by a user, modified or reconfigured to reflect changes to an expected community, or modified for other reasons such as redeployment of a system to a different network. A SL may include only a subset of the intended community, and the choice of seed addresses may be configured as desired.

Peer List

A “Peer List” (PL) is an exemplary data structure kept internally at each peer system and contains addresses of peer that are active or potentially active in a community. The PL at each node at least includes the seeding list content copied at initialization and may include nodes added as a result of one or more investigations performed by the node.

The PL data structure also may include status information about nodes. These status indicators may include categories such as connection status, peer type, and an indicator of the age of the information, such as a Timestamp.

In some exemplary embodiments, connection status at each remote node address in a PL may indicate one of four levels: “disconnected,” “to be connected,” “pending” or “connected.”

The “disconnected” status indicates that the local peer node has not received any indication that the remote peer node is present on the network, or that the local peer node failed to receive communication from the remote peer node for a predetermined period of time.

A remote peer address may be designated the next status level “to be connected” after a local peer determines the remote peer is active or reachable on the network, for example, after receiving a remote peer's response to a probe signal. Additionally, when a remote peer address is received via a response to a connection request, and that address is not the responding peer's address, the received peer address may be designated with status=to be connected and the local peer will attempt to connect to that newly discovered peer. In some embodiments, a remote peer address having the status=disconnected may be changed to status=to be connected if the local peer receives a presence message from the remote peer.

A remote address in the PL of the local peer node for which a connection request is sent from the local peer, but a response has not yet received, may be designated with status=pending.

A remote peer address may be designated with status=connected when the local peer receives a response to a connection request from that remote peer.

Each remote peer address in the PL may include a Type designation. The exemplary Type designations “regular” or “seed” are used herein. A designation Type=seed indicates that the address in the PL also is a seeding address and also present in the SL. All other listed peers would be designated Type=regular.

Probe Messages

Probe messages or signals are used to determine whether a particular node is reachable across a network. In the protocol described herein, a probe message or signal may be used to determine whether a potential peer can be reached before sending a connection request. Generally, almost any request/response flow can be used to determine whether a network node is reachable. In some embodiments, this may involve sending a Ping command to a particular host. For example, one type of Ping command uses the Internet Control Message Protocol (ICMP) “ECHO” facility to send “echo request” packets to a particular node and then listens for the “echo replies.” A Ping capability also may be implemented using alternate methods, such as using the UDP echo port (7), if supported, timing a Simple Network Management Protocol (SNMP) query, and timing a TCP connect attempt.

In some embodiments, a peer detection procedure may periodically, occasionally or repeatedly run at each peer node to send a probe signal or message to each remote peer listed in the PL having status=disconnected. When a successful response to a probe is received by the peer (e.g., receiving a Ping command response), the status of the corresponding responding node may be changed to status=to be connected. Such a peer detection procedure may run in the background while other processes are being performed and/or as frequently as desired. For example, peer detection may be throttled to probe a number of nodes each period of time and/or may be merged with other background processes described herein.

Presence Message

Each peer in the community may be configured to periodically provide a “Keep Alive” (KA) message to other peer addresses in the PL having the status “connected.” The KA message announces the sending peer's presence to those other peers and/or provides an indication or notification that the sending peer remains active in the community. The reception of a presence message from a remote peer, or non-receipt of a presence message for a predetermined period of time, may be used to update the status of that peer in the PL. For example, a local peer node receiving a presence message from a remote peer node known to be active (i.e., not “disconnected”) may update the timestamp in the PL that corresponds to the remote peer's address. A KA received from a peer having the status “disconnected” may cause the local peer to update the status to “to be connected” if the remote peer is listed in the peer list, and to add it to the PL if it is absent from the list.

Connection Request/Connection Response

A connection request is a message sent by a local peer to each remote peer address in the PL having the status=to be connected. The message contains information indicating the local peer's address and a list of each address in its PL having the status=connected. A connection request also requests information from the intended recipient node related to which nodes in the remote peer's PL have the status=connected. For each remote node address in a local peer node's PL to which the connection request is sent, the local peer sets the address status to Status=pending and Timestamp=current time.

In response to receiving a connection request, the receiving peer node updates the sender's address to address status to Status=connected, updates its PL to include address elements from the sending node that are not present in its PL, and sets Type=regular and status=to be connected for each newly added element. Thus, a connection request not only establishes a connection, but also initiates “learning” processes between two peers.

Timeout Timers

One or more timeout timers may be kept at each peer to enable various program modules to update or repeat discovery procedures and to perform maintenance. For example, a peer detection procedure may be throttled to send a probe message to a number of peers in the PL having status=disconnected during each time period defined by a timer. A timeout timer may keep a running count relative a stored Timestamp for a remote node. For example, a local node may detect a timer timeout after one or more unsuccessful Ping attempts to a remote node and remove the remote node's address (i.e., if it is a Type=regular, non-seed address) from its PL. Other timer timeouts may include detecting a timeout relative a Timestamp value while waiting for a response from the remote node (e.g., a response to a connection request), at timeout when remote node is non-responsive to any normal exchange (e.g., a TCP timeout), or a timeout before a KA message is received from the node. Timeout periods may be predetermined values and/or may occasionally be adjusted in accordance with network traffic volume and other latency variations.

Presence messages such as KA messages may be sent from one node to node addresses in its PL having Status=connected at regular intervals defined by a timeout timer, for example, a T_{KeepAlive} timer. The pace at which KA messages are sent may be greater than a timeout period kept for detecting loss of connection or communication with a remote node (e.g., a T_{KeepAlive} timer defines a shorter interval between sending KA messages than a timeout indicating a possible disconnection other loss of communication between the nodes). When a timeout of a KA timer for a remote peer occurs, the local peer will change the status of the remote peer address to status=disconnected. Thereafter, the remote node address may eventually be removed from the local PL if it is Type=regular and a subsequent Ping of the node is unsuccessful.

Returning now to FIG. 2, the following items outline aspects of auto-discovery protocol program modules 220 according to some embodiments:

Start/Restart Module 222 (Initialization)

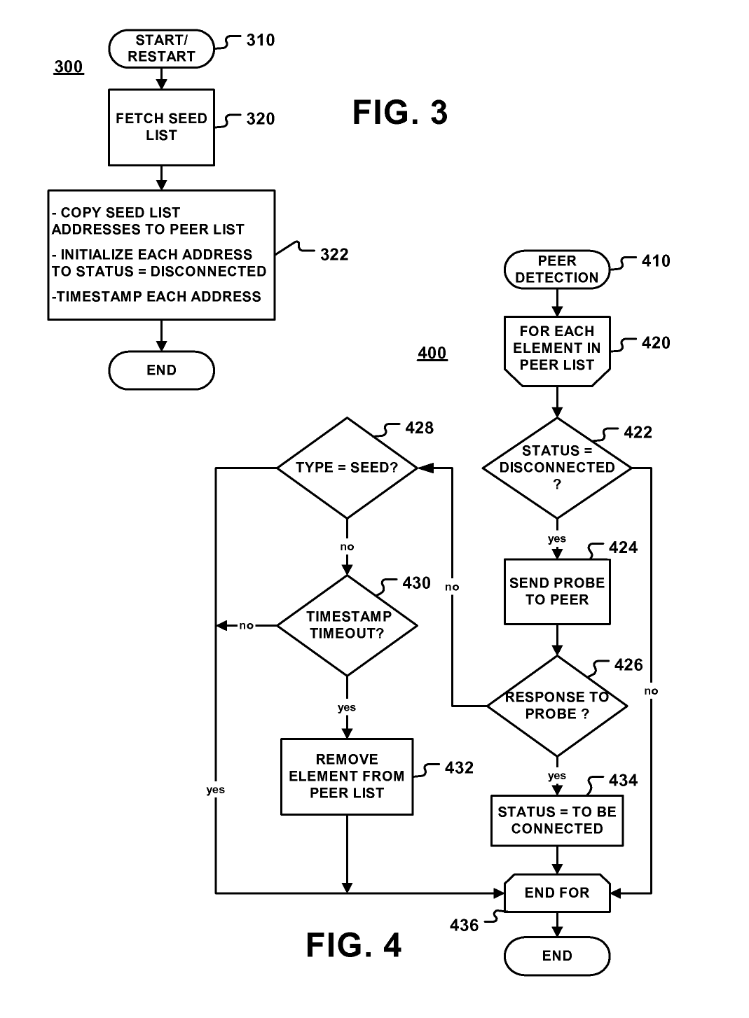

Each node in a community may be seeded with a number of known or expected potential peer addresses in its SL. FIG. 3 illustrates an exemplary Start/Restart procedure 300 performed in some embodiments when a node system including a SL is powered up or restarted. As shown in FIG. 3, after powering up or restarting a node device in process 310, process 320 fetches the SL from persistent memory of the node. In process 322, the SL is copied to the PL, each copied address entry's status is initialized to Status=disconnected, and each address is provided with a Timestamp=current time.

Peer Detection Module 224

FIG. 4 illustrates an exemplary peer detection procedure 400 for detecting potential peer nodes in a network in some embodiments. The processes of procedure 400 may be a background process throttled to perform a number of determinations each period of time. As shown in FIG. 4, peer detection 410 includes a loop 420-436 that selects a next IP address in the PL having status=disconnected in decision 422 and sends a probe message or signal (e.g., a Ping) to the selected IP address in process 424. If the probe is determined successful in decision 426, process 434 changes the IP address status to Status=to be connected.

If decision 426 determines that the probe is unsuccessful and decision 428 determines Type≠seed, process 430 verifies whether time elapsed since the Timestamp exceeds a timeout limit. If it does, the IP address element is removes as an entry in the PL in process 432. A timeout on seed probing (e.g., Pinging) may optionally be imposed, but doing so may limit bridging possibilities of the protocol.

Peer Connection/Learning Module 226: Regular Priority Processes

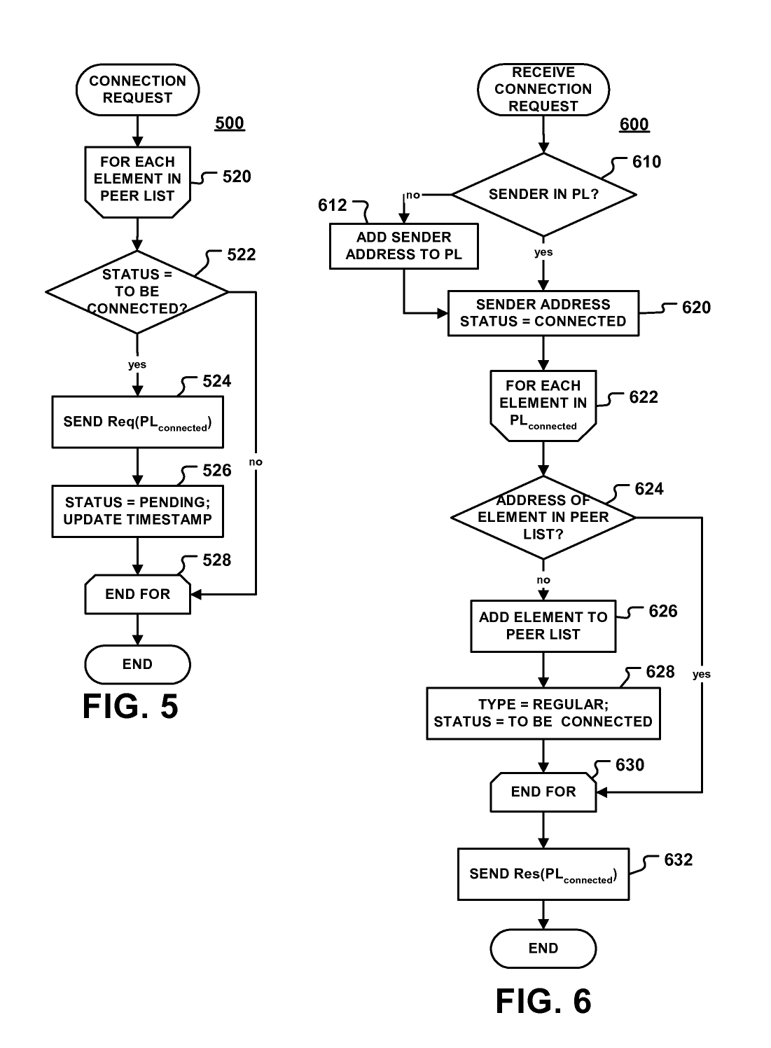

FIG. 5 illustrates an exemplary connection request procedure 500 for sending a connection request to a remote peer node according to some embodiments. Procedure 500 is a regular priority process that may be performed at a regular interval. The procedure 500 includes a loop 520-528 that examines each address element in the PL. Decision 522 of the loop selects a next IP address in the PL having Status=to be connected and process 524 sends a connection request (Req(PL_{connected})) to that IP address, where PL_{connected} is a list of all IP addresses from the local peer PL for which Status=connected. In process 526, the status of the IP address to which the message has been sent is changed to Status=pending and its Timestamp is set the Timestamp=current time.

FIG. 6 illustrates an exemplary receive connection request procedure 600 that may be performed in some embodiments for handling a connection request received at a peer node. The procedure 600 may be a regular priority process that may be invoked as requests are received. After receiving a connection request, the receiving node checks whether the sending node's address is in its PL at decision 610, and if not (i.e., “no” at 610), adds the address to the PL at process 612. Thereafter, process 620 sets the status of the IP address of the sending peer to Status=connected. If decision 610 determines that the sending address is present in the receiving node's PL, the “yes” path is taken to process 620 without performing process 612.

Loop processes 622 to 630 examine each element of the PL_{connected} list received from the requesting peer node. Again, a PL_{connected} includes only those addresses of the PL having Status=connected. Decision 624 determines whether an address element of the PL_{connected} is in the PL of the receiving peer node. If it is, process 626 inserts the IP address in receiving peer's PL (discarding duplicates of those already present in the PL), and process 628 marks the newly inserted addresses as Type=regular and Status=to be connected. In process 632, the receiving peer responds to the connection request by sending a connection response including a PL_{connected} to the peer that sent the request (e.g., a new peer being connected).

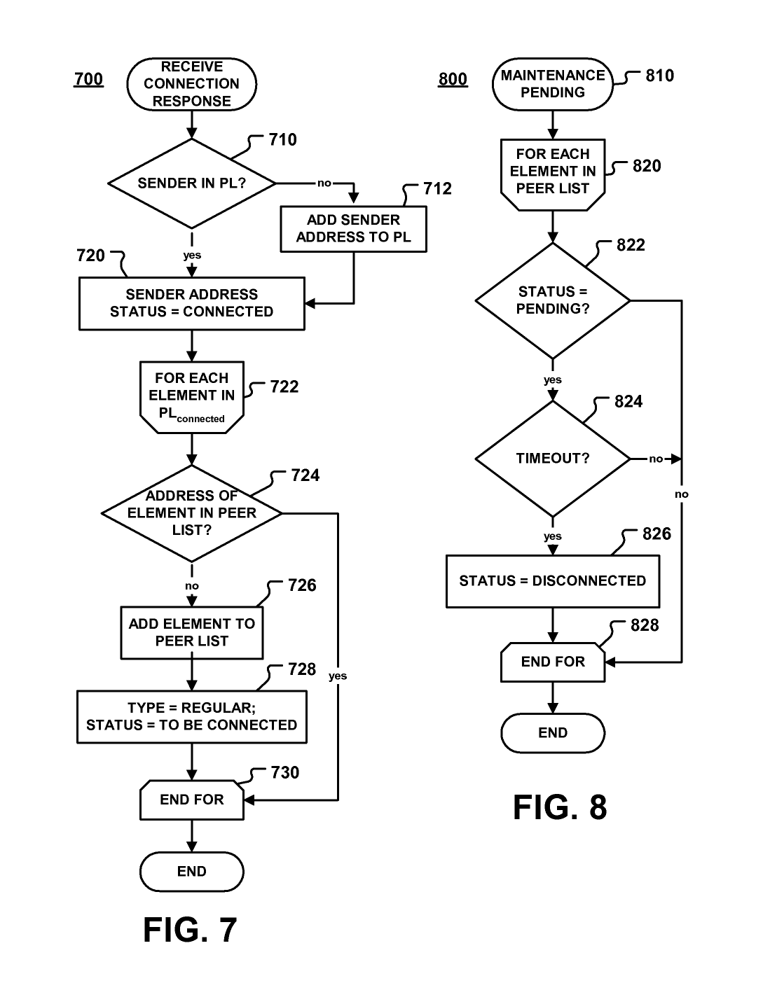

FIG. 7 illustrates a receive connection response procedure 700 performed in some embodiments for handling a connection response received by a peer node. The procedure 700 may be run as a regular priority process, for example, invoked as responses are received. More particularly, after receiving a connection response, at decision 710 the receiving node may check whether the sending node's address is in its PL. If not (i.e., “no” at 710), process 712 adds the sender's address to the PL. Thereafter, process 720 sets the IP address of the sending peer as Status=connected. If decision 710 determines that the sending address is present in the receiving node's PL, the “yes” path is taken from decision 710 to process 720 without performing process 712.

Loop processes 722 to 730 examine each element of the received PL_{connected} of the responding peer. Decision 724 determines, for each PL_{connected} element, whether that address element is in the PL of the receiving peer node. If not (i.e., “no” at 724), process 726 inserts the IP address in receiving peer PL, and process 728 marks each newly inserted address with Type=regular and Status=to be connected.

Peer List Maintenance Module 228

The Peer List Maintenance Module 228 performs a number of tasks including supervising the connectivity status of each peer, cleanup of unfinished connections, and cleanup of disconnected peers.

FIG. 8 is a flowchart illustrating a maintenance pending procedure 800 for addressing cleanup of unanswered pending requests in a peer node. Procedure 800 may be run as a background process (e.g., throttled to do a number each period of time). In the depicted loop 820-828, process 822 selects each IP address in the peer's PL which has the Status=pending, and if it is determined at decision 824 that an amount of time that has elapsed since the Timestamp is over a limit mark (e.g., a timeout), the status of that address is changed to Status=disconnected in process 826. Thereafter, the Peer Detection module 224 may eventually remove the peer node address from the local PL if it is Type=regular and a Ping of the corresponding node is unsuccessful.

FIG. 9 relates to a receive KA procedure 900 for supervising connectivity status in a PL of a peer. The procedure 900 provides an exemplary mechanism to maintain the connectivity status of the nodes in the community, although other mechanisms may use other existing communication mechanisms between the nodes as an indication of connectivity. More particularly, each peer sends KA messages to all peers in the PL with Status=connected, which may be performed as part of a priority process at a regular interval and at a pace faster than a timeout period. The procedure 900 may be designated a regular priority process that handles KA messages as they are received.

After a peer node receives a KA messages at process 910, decision 920 determines whether the sending peer node's address in the receiving node's PL. If it is not, process 926 adds the sending peer's address to the local peer's PL and process 928 sets the status for the added address to Status=to be connected. If decision 920 determines that the sending peer's address is in the local peer's PL and has Status=disconnected, the yes path is taken to process 928 where the status is changed to Status=to be connected. If the status determined at decision 922 is Status≠disconnected, the Timestamp of the sending address is updated to Timestamp=current time in the receiving node's PL.

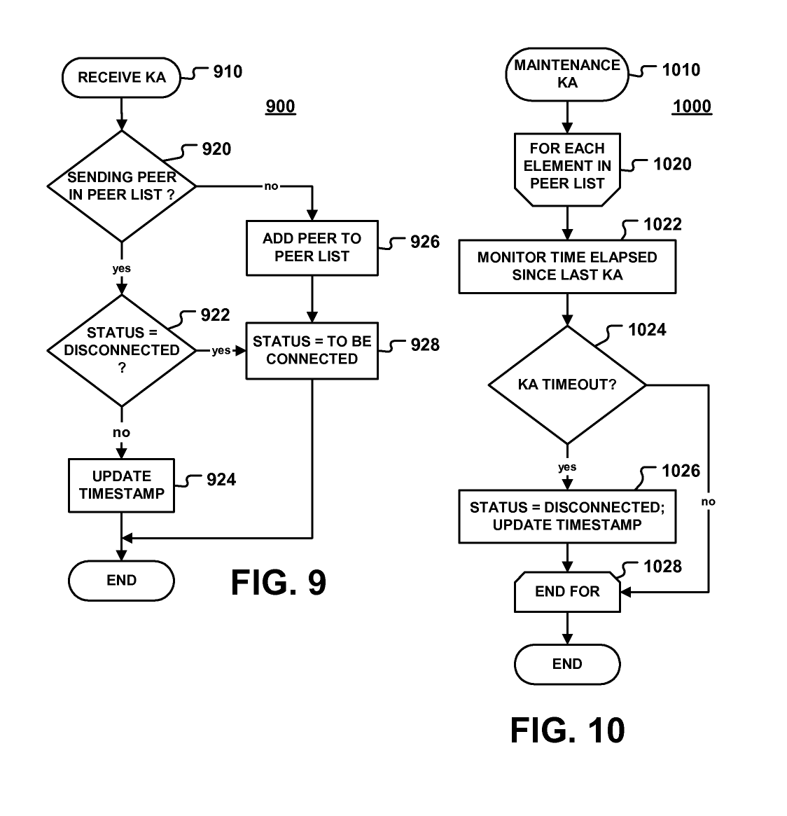

FIG. 10 illustrates an exemplary maintain KA procedure 1000 that may be implemented to allow the cleanup of disconnected nodes and prevent uncontrolled growth of a peer's PL. Cleanup of disconnected peers may be performed as a regular priority process (e.g., handled as it comes in). Procedure 1000 includes a loop 1020-1028 that represents a monitoring procedure performed for each peer node address. When a KA timeout is detected at decision 1022, process 1024 changes the status of the address corresponding to the peer of the expected KA to Status=disconnected and updates the Timestamp of that address in the PL. Thereafter, the Peer Detection module 224 may eventually remove the disconnected address from the local PL if it is Type=regular and a Ping of the node is unsuccessful.

Auto discovery protocols described herein provide robustness by maintaining peer status information of community members in each connected peer, and by detecting when other community members enter or leave the community through maintenance operations regularly performed at each peer node. The burden of initiating discovery and connection to existing peers an established network is placed on nodes entering the network.

The seed list maintained by the protocol provides both an initial list of community members to detect whether potential peers are present in the network after startup as well as a mechanism to recover when communication is interrupted. Accordingly, there is no need for a centralized or other server nodes to provide network topology to newcomer and existing peer nodes. However, such a server (or servers for redundancy and reliability) may be used, and the server's address may be included in the seed list to ensure community integrity. Additionally, a Type=regular peer may be converted to a Type=seed peer after being connected for a period of time and/or if a regular peer is discovered frequently.

To explain the inventive concepts of network discovery, embodiments have been described and depicted as having an order of execution. However, it is to be noted that the order of processes in the above procedures are exemplary, and thus embodiments may be implemented having processes in a different order without departing from the concepts described herein. Additionally, some applications may not include processes of the embodiments described in herein. For example, a test to determine whether a node is reachable (e.g., sending a probe message) before sending a connection request to that node may be optionally or conditionally performed, or even entirely omitted in some applications.

It will be apparent to those skilled in the art that various changes and modifications can be made in the network discovery methods and configurations of the present invention without departing from the spirit and scope thereof. Thus, it is intended that the present invention cover the modifications of this invention provided they come within the scope of the appended claims and their equivalents.

What is claimed is:

1. A method for node discovery in a network performed by each of a plurality of peer network nodes linked in the network, comprising:
maintaining at a network node a persistent list containing at least one remote peer node address;
copying each remote peer node address stored in the persistent list to a peer list stored at the network node;
sending a connection request message to each remote peer node in the peer list, wherein said connection request message contains any remote peer node address stored in the peer list of the network node having an indication of an established connection to one of the plurality of peer network nodes;
receiving a connection request reply from at least one said remote peer node to which a connection request message was sent, each said reply containing any address stored in a peer list at the responding remote peer node having a status indicator indicating a connection established between the responding remote peer node and one of the plurality of network peer nodes;
adding any address contained in any received reply to the peer list of the network node, if that address is absent from the peer list of the network node;
adding the address of any responding remote peer node to the peer list of the network node; and
providing, for each added responding remote peer node address, a status indicator indicating that a connection has been established between the network node and that responding remote peer node.

2. The method of claim 1, further comprising:
determining whether each said remote peer node at each address in the peer list is reachable; wherein sending said connection request message is performed only to those remote nodes determined reachable.

3. The method of claim 2, wherein determining whether each remote peer node is reachable comprises:
sending a probe message to each remote peer node address copied into the peer list; and
receiving a return message in response to the probe message.

4. The method of claim 1, further comprising:
periodically sending a presence message to each remote peer node address stored in the peer list of the network node having the status indicator indicating that a connection has been established.

5. The method of claim 1, further comprising:
monitoring a time period between incoming presence messages sent from each remote peer node having an address stored in the peer list of the network node that has the status indicator indicating that a connection has been established.

6. The method of claim 5, further comprising:
if any monitored time period exceeds a predetermined value, determining whether the corresponding remote peer node is reachable; and
removing the corresponding remote peer node from the peer list if determined to be unreachable.

7. The method of claim 1, further comprising:
monitoring a time period between each said connection request and connection request reply, and if the time period exceeds a predetermined value before receiving a connection request reply, determining whether the corresponding remote peer node to which the request was sent is reachable; and
removing the corresponding remote peer node from the peer list if determined to be unreachable.

8. The method of claim 1, further comprising:
receiving a connection request message from at least one said plurality of peer network nodes, each said request containing any address stored in a peer list of the sending peer node having a status indicator indicating a connection established between the sending peer node and another one of the plurality of network peer nodes.

9. The method of claim 8, further comprising:
sending a reply to the sender of each said received connection request, each said reply containing any remote peer node address stored in the peer list of the network node having an indication of an established connection to one of the plurality of network peer nodes;
adding the address of each sender of a connection request to the peer list of the network node; and
providing, for each added sender address, a status indicator indicating that a connection has been established between the network node and that sending node.

10. The method of claim 3, further comprising:
monitoring a time period after sending each said probe message, and if the time period exceeds a predetermined value before receiving a return message, removing the corresponding remote peer node from the peer list.

11. The method of claim 2, wherein the probe message is a Ping command.
